(19) United States
(12) Patent Application Publication
(10) Pub. No.: US 2009/0182759 A1
(43) Pub. Date: Jul. 16, 2009

(54) EXTRACTING ENTITIES FROM A WEB PAGE

(75) Inventor: Alok S. Kirpal, Bangalore (IN)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 12/013,289

(22) Filed: Jan. 11, 2008

(51) Int. Cl. G06F 17/30

(52) U.S. Cl. 707/102; 707/E17.044

(57) ABSTRACT

A method for extracting entities from a web page includes first applying a high precision low recall (HPLR) technique on a first web page, producing one or more entities extracted from the first web page. Then a sequential model is trained using the one or more entities extracted from the first web page. The sequential model is then performed on a second web page, producing one or more entities extracted from the second web page.

### BACKGROUND OF THE INVENTION

1. Field of the Invention

The present invention relates to Internet web sites. More particularly, the present invention relates to extracting entities from a web page.

2. Description of the Related Art

The Internet contains an enormous amount of data. It is typical for users to gain access to such data via a search engine or directory. Search engines are primarily keyword-based, yet not all words on a web page have the same significance. In order to search through the data quickly and efficiently, it is necessary to have a system that organizes the data on the web page prior to a user conducting a search.

A class of techniques utilized to extract entities and attributes from web pages is known as template-based techniques. In template-based techniques, a template is learned from structurally similar web pages of a site and a user familiar with a type of web site annotates the template, indicating where certain types of information is typically found on a page. For example, a user familiar with the format of an online bookstore's web pages can create a template for the product pages indicating where the title, author, date, price, etc. of the book are likely to be found. A particular books web page may then be indexed using the template based technique by comparing the web page to the template and extracting and organizing the corresponding data from the web page. One common template-based technique is known as Wrapper Induction (WI).

Template-based techniques like WI and other rule-based techniques belong to the class of High Precision-Low Recall (HPLR) techniques because of their common performance results. Precision refers to the accuracy of the system in extracting information from a matching web page, whereas recall refers to the percentage of web pages that are matched. In other words, these template based systems are extremely accurate for web pages that match the user-defined template, but for web pages that stray from the template, even a little, the systems are typically unable to extract and/or organize appropriate information.

### SUMMARY OF THE INVENTION

A method for extracting entities from a web page includes first applying a high precision low recall (HPLR) technique on a first web page, producing one or more entities extracted from the first web page. Then a sequential model is trained using the one or more entities extracted from the first web page. The sequential model is then performed on a second web page, producing one or more entities extracted from the second web page.

### BRIEF DESCRIPTION OF THE DRAWINGS

FIG. 1 is a diagram illustrating an example of a method for extracting entities from web pages in accordance with an embodiment of the present invention.

FIG. 2 is a flow diagram illustrating a method in accordance with another embodiment of the present invention.

FIG. 3 is an exemplary network diagram illustrating some of the platforms that may be employed with various embodiments of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In an embodiment of the present invention, a web site may be clustered into clusters of structurally similar web pages. A user may then create a template for one or more of the clusters. Data from web pages in those clusters may then be extracted using a template-based technique, resulting in extracted entities. While this template based technique operates with a high precision, it also typically results in low recall. Thus, unless the user is able to make templates for each type of similar structured web page, a large number of entities from other web pages may go unextracted and unindexed. In order to remedy this, in an embodiment of the present invention, the template-based technique is supplemented by using the extracted entities from a successful operation of the template-based technique as input to a sequential model. This input is used by the sequential model to train the system to better recognize entities. The sequential model may then be applied to any clusters for which the user did not create a template.

For purposes of this document, a sequential model shall be interpreted as any technique that builds a probabilistic model for segmenting and labeling sequential data. In one embodiment of the present invention, the sequential model utilized is a Conditional Random Field (CRF) technique.

In a CRF technique, the model defines a conditional probability p (Y|x) over label sequences given a particular observation sequence x. Conditional models are then used to label a novel observation sequence x* by selecting the label sequence y* that maximizes the conditional probability p (y*|x*). The conditional nature of such models means that no effort is wasted on modeling the observations. As such, arbitrary attributes of the observation data may be captured without the modeler having to worry about how these attributes are related. The CRF is a form of an undirected graphical model that defines a single log-linear distribution over label sequences given a particular observation sequence.

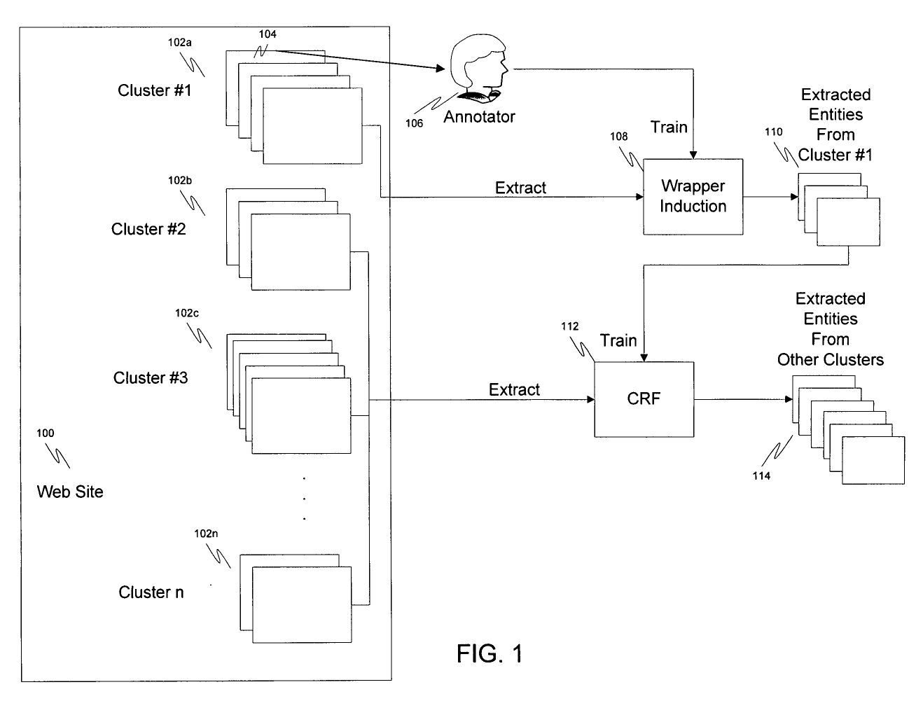

FIG. 1 is a diagram illustrating an example of a method for extracting entities from web pages in accordance with an embodiment of the present invention. In this embodiment, a web site 100 is comprised of one or more clusters 102a-102n of web pages. Each cluster 102a-102n is comprised of structurally similar web pages. A user known as an annotator 106 takes a web page 104 from a first cluster 102a and trains an HPLR technique on it. In this embodiment, the HPLR technique is wrapper induction 108. Training the HPLR technique may include the annotator 106 annotating (i.e., marking attributes) from the web page 104. Wrapper Induction 108 then uses this information to learn an annotated wrapper that can be applied to other web pages in the same cluster 102a to extract annotated entities 110.

Then these extracted annotated entities 110 may be used to train a sequential model such as CRF 112. In the online bookstore example, through training the system may compile a list of titles of books (or other dictionary features). The list of titles may then be used to determine which content items represent titles in other clusters. At this point, whenever it is desired to extract entities from web pages from the other clusters 102b-102n (presumably on which the wrapper induction would fail), the sequential model 112 may be used to perform the extraction, resulting in a set of extracted entities 114 that would ordinarily not be extracted using the HPLR technique alone.

In an embodiment of the present invention, the representation of web pages is converted prior to use of the sequential model 112 in order to improve performance. Specifically, sequential models, and CRFs in particular, operate more effectively when web pages are represented in an intelligent way. In this embodiment, web pages are represented in a way that captures structural as well as content properties of the web pages. This may be accomplished by, for example, generating a data sequence by performing in-order traversal over a Hyper Text Markup Language (HTML) Document Object Model (DOM) tree representing the web page, and retaining only the leaf level nodes. These leaf level nodes are also considered to be tokens. Each token may then be associated with a list of features.

Structural features capture the structural similarity for attributes (e.g., the path of product-title in the DOM tree across pages is the same, or they are all contained within the same HTML tag). Content features are more general features which capture the content characteristics (e.g., the introductory text of a product price is similar across different product pages).

In an embodiment of the present invention, a linear chain CRF is used to capture sequential dependencies between tokens of a data sequence. Linear chain is an embodiment of CRF where the dependency graph is a simple Markov chain. Nothing in this document shall be read to restrict the invention to linear chain topology CRFs. Further, CRFs are just one of the possible sequential models that may be used in the present invention, and nothing in this document shall be interpreted as limiting the scope to any particular technique.

Furthermore, the use of CRFs for extraction provides probabilistic confidence scores on each of the entities. These confidence scores can further be used to make judgments about the entities. For example, the confidence score may indicate that the system is 90% sure that an extracted entity represents a title. This information may be utilized in a number of different ways. The annotator or another user may be provided with these confidence scores and the annotator or user may then make a decision as to whether to accept the system's recommendation as to the extracted entity. Alternatively, or in conjunction with the annotator or user being provided with a choice as to whether to accept the system's recommendation, a series of threshold values may be established above which the system's recommendations are accepted automatically. For example, the system may be designed to automatically accept any entity recommendations whose confidence score is greater than 90% and automatically reject any entity recommendations whose confidence score is less than 70%, with confidence scores in the middle causing the system to prompt the annotator or user for a decision.

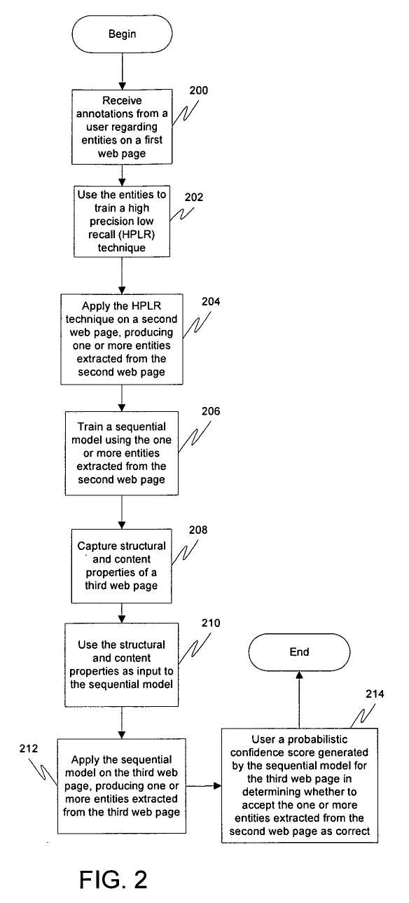

FIG. 2 is a flow diagram illustrating a method in accordance with another embodiment of the present invention. At 200, annotations may be received from a user regarding entities on a first web page. At 202, the annotations may be used to train a high precision low recall (HPLR) technique. At 204, the HPLR technique is applied on a second web page, producing one or more entities extracted from the second web page. This HPLR technique may be a template based technique such as, for example, wrapper induction. At 206, a sequential model is trained using the one or more entities extracted from the second web page. This may include first converting the second web page into a sequence by traversing the DOM tree representing the second web page and retaining the nodes of interest. In one embodiment, the DOM traversal is an in-order traversal that retains only leaf-level nodes. The structural and content properties of each node may be captured and given as input to the sequential model, which learns the structural and content property interdependencies. The sequential model may be, for example a linear chain CRF. At 208, structural and content properties of a third web page may be captured. This capturing may be similar to the capturing described above with respect to one embodiment of step 206. At 210, the structural and content properties may be used as input to the sequential model. At 212, the sequential model is applied on the third web page, producing one or more entities extracted from the third web page. At 214, a probabilistic confidence score generated by the sequential model for the third web page may be used in determining whether to accept the one or more entities extracted from the second web page as correct.

In one example embodiment, the extracted entities are utilized to populate a search engine or directory. Specifically, the entities are utilized to organize the content of the web site in the search engine or directory according to the type of each piece of content. For example, in an online bookstore example, each book's title may be indexed in the search engine or directory along with metadata indicating that the content is the title. Likewise, the publisher of each book may be indexed in the search engine or director along with metadata indicating that the content is the publisher. Subsequently, when searches are conducted, the search engine or directory may weigh keyword matches on content indexed as a book title greater than it may weigh keyword matches on content indexed as a publisher, since it is more likely that a user would be attempting to locate a book based on title than on publisher. Therefore, for example, if a user typed in the phrase “random numbers,” then the search engine or directory would weigh content that includes a book title called “random variations” higher than content that includes a publisher named “Random House.”

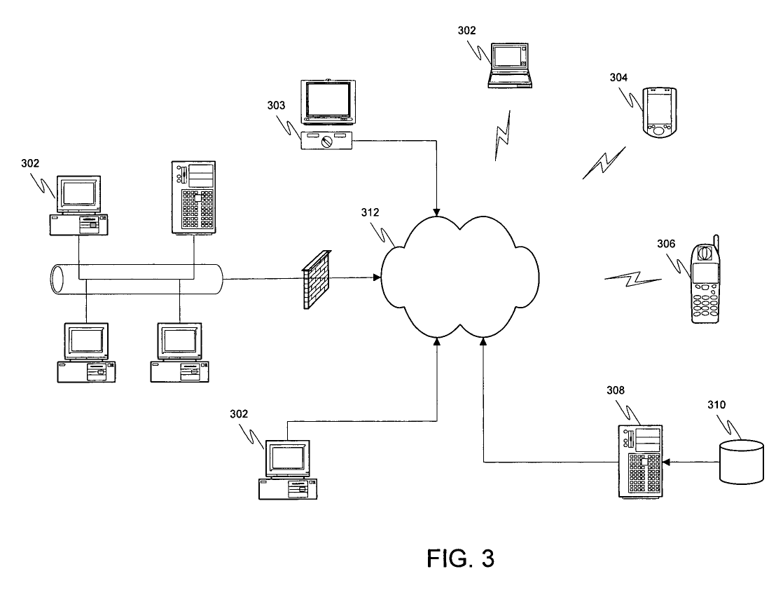

It should also be noted that embodiments of the present invention may be implemented on any computing platform and in any network topology in which presentation of service results is a useful functionality. For example and as illustrated in FIG. 3, implementations are contemplated in which the invention is implemented in a network containing personal computers 302, media computing platforms 303 (e.g., cable and satellite set top boxes with navigation and recording capabilities (e.g., Tivo)), handheld computing devices (e.g., PDAs) 304, cell phones 306, or any other type of portable communication platform. Users of these devices may navigate the network. A user may utilize a mobile device such as 304 and 306 to perform client-side macros and/or to request that a server run server-side macros. Server 308 (or any of a variety of computing platforms) may include a memory, a processor, and a communications component and may then utilize the various techniques described above. The processor of the server 308 may be configured to run, for example, all of the processes described in FIG. 1 or 2. Server 308 may be coupled to a database 310, which stores information relating to the extraction of entities. Applications may be resident on such devices, e.g., as part of a browser or other application, or be served up from a remote site, e.g., in a Web page (also represented by server 308 and database 310). The invention may also be practiced in a wide variety of network environments (represented by network 312), e.g., TCP/IP-based networks, telecommunications networks, wireless networks, etc. The invention may also be tangibly embodied in one or more program storage devices as a series of instructions readable by a computer (i.e., in a computer readable medium).

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method comprising:
applying a high precision low recall (HPLR) technique on a first web page, producing one or more entities extracted from the first web page;
training a sequential model using the one or more entities extracted from the first web page;
applying the sequential model on a second web page, producing one or more entities extracted from the second web page.

2. The method of claim 1, wherein the HPLR technique is a template-based technique.

3. The method of claim 2, wherein the template-based technique is Wrapper Induction (WI).

4. The method of claim 1, wherein the sequential model is a conditional random field (CRF).

5. The method of claim 4, wherein the CRF is a linear-chain CRF.

6. The method of claim 1, further comprising:
receiving annotations from a user regarding entities on a third web page; and
using the annotations to train the high precision low recall (HPLR) technique prior to applying the high precision low recall (HPLR) technique on the first web page.

7. The method of claim 1, further comprising:
capturing structural and content properties of the second web page and using the structural and content properties as input to the sequential model prior to applying the sequential model on a second web page.

8. The method of claim 7, wherein the capturing structural and content properties of the second web page comprises:
applying in-order traversal of a Document Object Model (DOM) tree representing the second web page; and
retaining only leaf level nodes from the in-order traversal.

9. The method of claim 1, further comprising:
using a probabilistic confidence score generated by the sequential model for the second web page in determining whether to accept the one or more entities extracted from the second web page as correct.

10. A server comprising:
an interface; and
one or more processors configured to perform the following steps:
applying a high precision low recall (HPLR) technique on a first web page, producing one or more entities extracted from the first web page;
training a sequential model using the one or more entities extracted from the first web page;
applying the sequential model on a second web page, producing one or more entities extracted from the second web page.

11. The server of claim 10, wherein the HPLR technique is a template-based technique.

12. The server of claim 11, wherein the template-based technique is Wrapper Induction (WI).

13. The server of claim 10, wherein the sequential model is a conditional random field (CRF).

14. The server of claim 13, wherein the CRF technique is a linear-chain CRF.

15. The server of claim 10, wherein the one or more processors are further configured to perform the following steps:
receiving annotations from a user regarding entities on a third web page; and
using the annotations to train the high precision low recall (HPLR) technique prior to applying the high precision low recall (HPLR) technique on the first web page.

16. The server of claim 10, wherein the one or more processors are further configured to perform:
capturing structural and content properties of the second web page and using the structural and content properties as input to the sequential model prior to applying the sequential model on a second web page.

17. The server of claim 16, wherein the capturing structural and content properties of the second web page comprises:
performing in-order traversal of a Document Object Model (DOM) tree representing the second web page; and
retaining only leaf level nodes from the in-order traversal.

18. The server of claim 10, wherein the one or more processors are further configured to:
use a probabilistic confidence score generated by the sequential model for the second web page in determining whether to accept the one or more entities extracted from the second web page as correct.

19. A program storage device readable by a machine tangibly embodying a program of instructions executable by the machine to perform a method comprising:
applying a high precision low recall (HPLR) technique on a first web page, producing one or more entities extracted from the first web page;
training a sequential model using the one or more entities extracted from the first web page;
applying the sequential model on a second web page, producing one or more entities extracted from the second web page.
